(19) United States
(12) Patent Application Publication
(10) Pub. No.: US 2020/0090619 A1
(43) Pub. Date: Mar. 19, 2020

(54) METHOD FOR DYNAMIC FREQUENCY COMPENSATION AND DYNAMIC FREQUENCY COMPENSATION SYSTEM

(71) Applicant: Raydium Semiconductor Corporation, Hsinchu (TW)

(72) Inventors: CHIH-HAO WANG, Taichung City (TW); SHENG-YI LIN, Hsinchu City (TW)

(21) Appl. No.: 16/394,184

(22) Filed: Apr. 25, 2019

(30) Foreign Application Priority Data
Sep. 14, 2018 (TW) 107132521

(51) Int. Cl. G09G 5/00

(52) U.S. Cl. CPC G09G 5/003

(57) ABSTRACT

A method for dynamic frequency compensation is provided, the method includes the following steps: (A) presetting a frequency difference associated with a display signal and a clock signal; (B) receiving a current display signal from a controller by a driver, wherein the current display signal has a first frequency, and receiving a current clock signal inside the driver, wherein the current clock signal has a second frequency; (C) comparing the first frequency with the second frequency, and generating a comparison result; and (D) modulating the second frequency according to the comparison result and the frequency difference.

### BACKGROUND

### Technical Field

The present invention relates to a method for dynamic frequency compensation and a dynamic frequency compensation system. Specifically, the present invention relates to a method for dynamic frequency compensation and a dynamic frequency compensation system for a display device.

### Related Art

A change in temperature may affect an oscillator to speed up (or slow down) a signal received by a driver of a display device. As a result, an exception may occur when the driver reads or writes data. A conventional way is to make temperature compensation. However, as exceptions accumulate, an exception may still occur when the driver reads or writes data. Therefore, the conventional way needs to be improved.

### SUMMARY

An object of the present invention is to provide a method for dynamic frequency compensation to reduce frequency variation.

An object of the present invention is to provide a method for dynamic frequency compensation to improve display picture quality.

A method for dynamic frequency compensation includes the following steps: (A) presetting a frequency difference associated with a display signal and a clock signal; (B) receiving a current display signal from a controller by a driver, wherein the current display signal has a first frequency; and receiving a current clock signal inside the driver, wherein the current clock signal has a second frequency; (C) comparing the first frequency with the second frequency, and generating a comparison result; and (D) modulating the second frequency according to the comparison result and the frequency difference.

A dynamic frequency compensation system includes a controller and a driver. The driver is coupled to the controller. The controller generates a current display signal having a first frequency. The driver is preset with a frequency difference associated with a display signal and a clock signal, and the driver generates a current clock signal having a second frequency and receives the current display signal from the controller. The driver compares the first frequency with the second frequency and generates a comparison result. The driver modulates the second frequency according to the comparison result and the frequency difference.

### BRIEF DESCRIPTION OF THE DRAWINGS

FIG. 1 is a flowchart of an embodiment of a method for dynamic frequency compensation according to the present invention;

FIG. 2 is a flowchart of an embodiment of a dynamic frequency compensation system according to the present invention;

FIG. 3 is a flowchart of another embodiment of a method for dynamic frequency compensation; and

FIG. 4 is a flowchart of another embodiment of a dynamic frequency compensation system.

### DETAILED DESCRIPTION

A method for dynamic frequency compensation and a dynamic frequency compensation system utilizing this method are provided. The dynamic frequency compensation system is disposed inside a display device. The display device is, for example, a mobile phone, but is not limited thereto. The dynamic frequency compensation system receives different signals and maintains a speed difference between the signals according to a preset frequency difference. By means of the method for dynamic frequency compensation, an exception that occurs during reading or writing of data due to an excessively large frequency difference between received signals can be prevented.

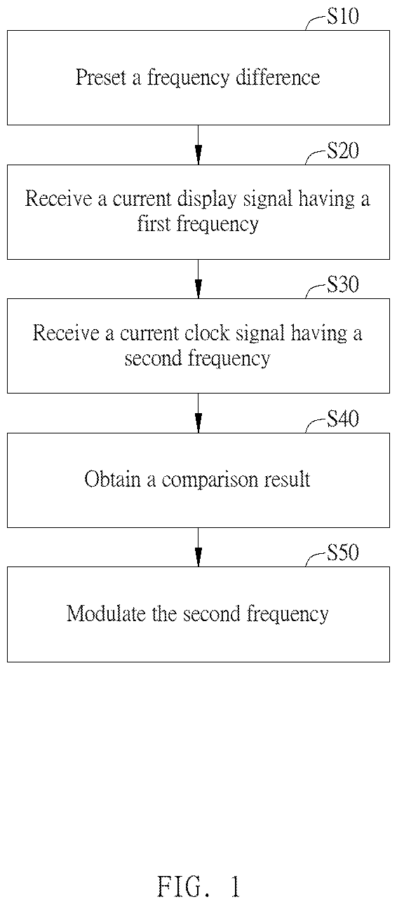

FIG. 1 is a flowchart of an embodiment of a method for dynamic frequency compensation according to the present invention. As shown in FIG. 1, the method for dynamic frequency compensation includes steps S10 to S50. In step S10, a frequency difference associated with a display signal and a clock signal is preset. In step S20, a driver receives a current display signal from a controller, wherein the current display signal has a first frequency. In step S30, a current clock signal inside the driver is received, wherein the current clock signal has a second frequency. In step S40, the first frequency is compared with the second frequency, and a comparison result is generated. In step S50, the second frequency is modulated according to the comparison result and the frequency difference.

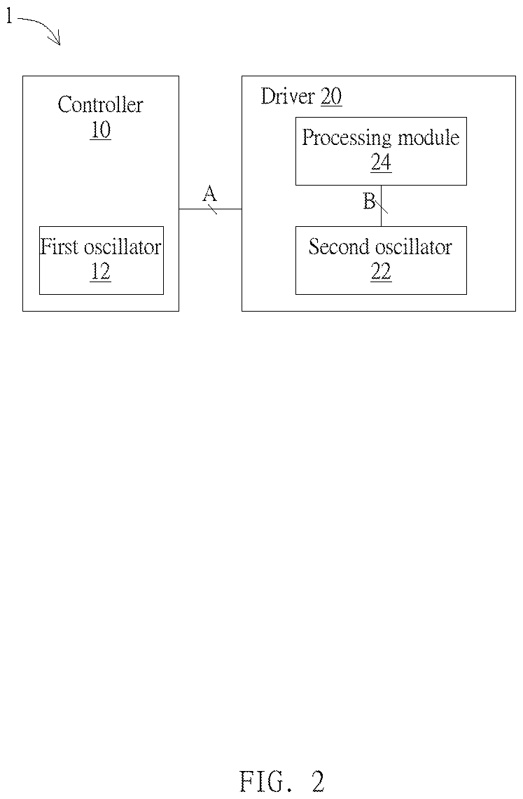

FIG. 2 is a flowchart of an embodiment of a dynamic frequency compensation system 1 according to the present invention. As shown in FIG. 2, the dynamic frequency compensation system 1 includes a controller 10 and a driver 20 coupled to the controller 10. The controller 10 generates a current display signal A having a first frequency. For example, the controller 10 generates the current display signal A according to a first oscillator 12 located in the controller 10. The current display signal A is, for example, a horizontal synchronization signal or a vertical synchronization signal. The driver 20 generates a current clock signal B having a second frequency and receives the current display signal A from the controller 10. For example, the driver 20 generates the current clock signal B according to a second oscillator 22 located in the driver 20. The driver 20 is, for example, a driving integrated circuit. The driving integrated circuit reads and writes image data according to the current clock signal. In addition, the driver 20 is preset with a frequency difference associated with a display signal and a clock signal. For example, a frequency of a clock signal is preset to be 1.5 times faster than a frequency of a display signal. Based on this relationship, a frequency difference is set. The frequency difference is used as a target value of correction and represents a speed difference between the display signal and the clock signal. The value of the frequency difference may be adjusted based on product types and display requirements.

In the embodiment in FIG. 2, the driver 20 compares the first frequency with the second frequency, and generates a comparison result. For example, the driver 20 includes a processing module 24, and compares the first frequency with the second frequency by the processing module 24 in the driver 20. The comparison result reflects a speed difference between the current display signal A and the current clock signal B. For example, if the current clock signal A is excessively slow, the image data may fail to be processed in time. For a driver that integrates touch and display, processing of touch data by the driver is further affected, resulting in exceptions in system processing. In another example, if the current clock signal A is excessively fast, the driver may read image data that have not been updated, and a reading error occurs. The driver 20 modulates the second frequency according to the comparison result and the frequency difference.

For example, the speed of the current display signal and the current clock signal may change with ambient temperature. When the ambient temperature changes, a frequency drift may occur in a signal. By means of the foregoing process, the current clock signal is adjusted to be fast accordingly when the current display signal is relatively fast. In contrast, the current clock signal is adjusted to be slow accordingly when the current display signal is relatively slow. In this way, a change in the frequency difference between the signals that is caused by frequency variation is reduced, so that the speed difference between the display signal and the clock signal can stay consistent, and an exception does not occur when the driver reads or writes data.

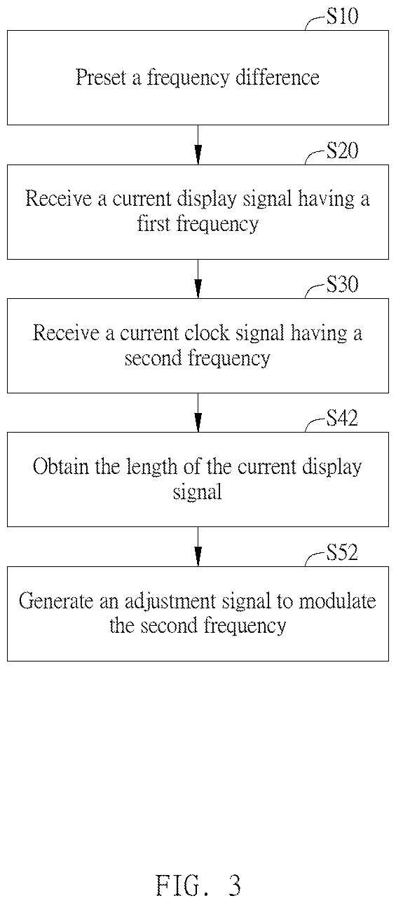

FIG. 3 is a flowchart of another embodiment of a method for dynamic frequency compensation. As shown in FIG. 3, the method for dynamic frequency compensation includes steps S10 to S52. Content of steps S10 to S30 is as described above. In step S42, a detection module calculates the length of the current display signal in a period according to the current clock signal, and uses the length as the comparison result. For example, a quantity of pulses is calculated in the current display signal in a period, so that the length of the current display signal is obtained. In step S52, an adjustment module generates an adjustment signal according to the length of the current display signal and the preset frequency difference. The second frequency is modulated according to the adjustment signal.

In an embodiment, a tolerance range is defined for the frequency difference according to an error range. In the method for dynamic frequency compensation, the driver may be further used in a modulation stage of the second frequency to modulate the second frequency as the first frequency changes, so that a difference between the first frequency and the second frequency conforms to the tolerance range. For example, a frequency of the clock signal is set to be 1.5 times faster than a frequency of the display signal. Based on the error range, a tolerance range is that the frequency of the clock signal is further set to be 1.48 times to 1.52 times faster than the frequency of the display signal. The foregoing tolerance range is used as a target range of correction. The driver modulates the second frequency, so that the speed difference between the display signal and the clock signal can stay consistent and can be within the tolerance range.

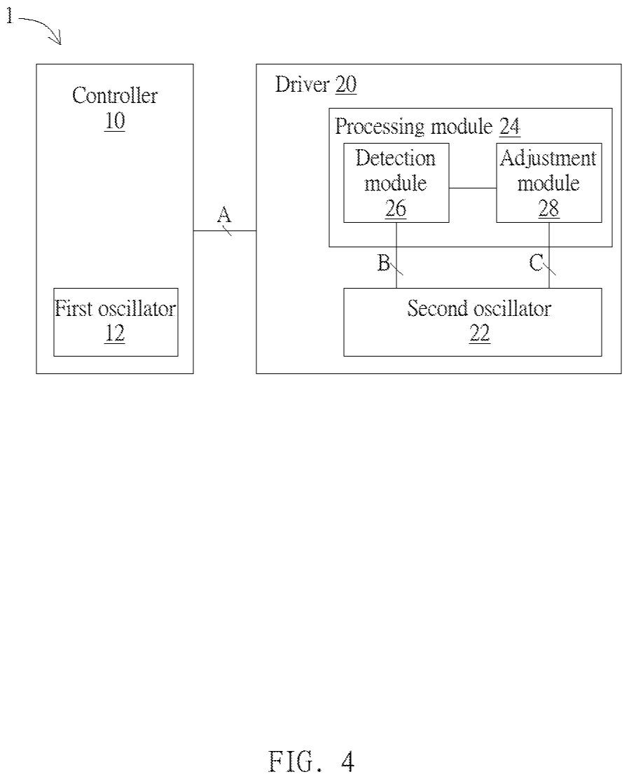

FIG. 4 is a flowchart of another embodiment of a dynamic frequency compensation system 1. As shown in FIG. 4, the dynamic frequency compensation system 1 includes a controller 10 and a driver 20 coupled to the controller 10. The controller 10 generates a current display signal a having a first frequency. The driver 20 generates a current clock signal B having a second frequency and receives the current display signal A from the controller 10. A difference from the foregoing embodiment lies in that the driver 20 includes a detection module 26 and an adjustment module 28. The detection module 26 and the adjustment module 28, for example, are different circuit blocks in the processing module 24. The detection module 26 calculates the length of the current display signal A in a period according to the current clock signal B, and the length is used as the comparison result. In an embodiment, the detection module 26 is a counter and calculates a quantity of pulses of the current display signal in a period, thereby obtaining the length of the current display signal.

As shown in FIG. 4, the adjustment module 28 generates an adjustment signal C according to the length of the current display signal and the frequency difference, and modulates the second frequency according to the adjustment signal C. For example, the adjustment signal C has a plurality of different shifts that correspond to different frequency modulation amounts. The generated adjustment signal C includes a selection corresponding to a specific shift according to a degree of the speed difference between the current display signal A and the current clock signal B that are reflected by the comparison result. In this way, frequency variation can be reduced according to the adjustment signal, so that a speed difference between the display signal and the clock signal can stay consistent. When the speed difference between the display signal and the clock signal can stay consistent, an exception can be prevented when a driver reads or writes image data, thereby improving display picture quality.

The present invention has been described by using the foregoing related embodiments. However, the foregoing embodiments are only examples for implementing the present invention. It should be noted that the disclosed embodiments do not limit the scope of the present invention. On the contrary, the present invention is intended to cover modifications and equivalent arrangements included within the spirit and scope of the appended claims.

What is claimed is:

1. A method for dynamic frequency compensation, comprising the following steps:
(A) presetting a frequency difference associated with a display signal and a clock signal;
(B) receiving a current display signal from a controller by a driver, wherein the current display signal has a first frequency, and receiving a current clock signal inside the driver, wherein the current clock signal has a second frequency;
(C) comparing the first frequency with the second frequency, and generating a comparison result; and
(D) modulating the second frequency according to the comparison result and the frequency difference.

2. The method according to claim 1, wherein in step (B), the current display signal is a horizontal synchronization signal or a vertical synchronization signal.

3. The method according to claim 1, wherein in step (C), a detection module calculates the length of the current display signal in a period as the comparison result according to the current clock signal.

4. The method according to claim 3, wherein in step (D), an adjustment module generates an adjustment signal according to the length of the current display signal and the frequency difference, and modulates modulating the second frequency according to the adjustment signal.

5. The method according to claim 1, wherein a tolerance range is defined for the frequency difference according to an error range, and in step (D), the driver modulates the second frequency as the first frequency changes, so that a difference between the first frequency and the second frequency conforms to the tolerance range.

6. A dynamic frequency compensation system, comprising:
a controller configured to generate a current display signal having a first frequency; and
a driver coupled to the controller, wherein the driver is preset with a frequency difference associated with a display signal and a clock signal, the driver generates a current clock signal having a second frequency and receives the current display signal from the controller, the driver compares the first frequency with the second frequency and generates a comparison result, and the driver modulates the second frequency according to the comparison result and the frequency difference.

7. The system according to claim 6, wherein the current display signal is a horizontal synchronization signal or a vertical synchronization signal.

8. The system according to claim 6, wherein the driver comprises:
a detection module configured to calculate the length of the current display signal in a period as the comparison result according to the current clock signal; and
an adjustment module configured to generate an adjustment signal according to the length of the current display signal and the frequency difference, and to modulate the second frequency according to the adjustment signal.

9. The system according to claim 6, wherein the detection module is a counter.

10. The system according to claim 6, wherein a tolerance range is defined for the frequency difference according to an error range, and the driver modulates the second frequency as the first frequency changes, so that a difference between the first frequency and the second frequency conforms to the tolerance range.
